(19) United States
(12) Patent Application Publication
(10) Pub. No.: US 2011/0067540 A1
(43) Pub. Date: Mar. 24, 2011

(54) TABLE SAW WITH MOVABLE TABLE AND STATIONARY RIP FENCE

(75) Inventors: ANDREW FROLOV, GLENVIEW, IL (US); JASON FELDNER, MT. PROSPECT, IL (US); JIM BOHN, BRISTOL, WI (US)

(73) Assignee: CREDO TECHNOLOGY CORPORATION, BROADVIEW, IL (US)

(21) Appl. No.: 12/566,300

(22) Filed: Sep. 24, 2009

(51) Int. Cl. B23D 45/06; B23D 47/02; B27B 27/02; B27B 5/24

(52) U.S. Cl. 83/467.1; 83/477.2; 83/477.1; 83/473; 83/859

(57) ABSTRACT

Embodiments of a power table saw are described which have a frame structure configured to support a movable saw assembly. The table saw also includes a rip fence attached to the frame structure in a fixed position for contacting a work piece during a cutting operation by said table saw. Further, a table assembly is provided, having a top surface for supporting a work piece, a blade extendable through an opening in the top surface for cutting a work piece, and a motor mounted beneath the top surface for driving the blade. The table assembly is movably mounted on the frame structure so that the table assembly is adjustable, allowing adjustment of the distance between the blade and the rip fence.

### BACKGROUND OF THE INVENTION

The present invention is generally related to table saws, and more particularly to portable table saws.

Conventional table saws generally include a movable rip fence used to guide a piece of material, such as wood, as it is pushed towards a blade for cutting. The movable rip fence is generally designed to span between the front and rear edges of the cutting surface. The rip fence can be secured in position a given distance from the blade and is arranged to be generally parallel to the blade. In this way, a user can guide the material to be cut along the rip fence, cutting the material to a given width.

While the rip fence must be parallel to the blade for the table saw to operate properly and make accurate cuts, many rip fence designs are prone to some amount of misalignment from parallelism of the rip fence and blade. A misaligned rip fence can cause inaccurate cuts and can bind the blade as well as cause a buildup of excess heat in both the saw and the work piece. Excess heat in the material can cause scorch marks on the work piece. Additionally, misalignment of the fence relative to the saw blade results in increased drag on the saw blade causing the saw blade to slow down and resulting in a non-uniform, uneven cut. Further, misalignment can cause the work piece to bind in the saw blade, which may result in undesirable and dangerous “kickback,” where the work piece is thrown violently by the saw blade back toward the operator. Accordingly, it is important to maintain parallel alignment between the rip fence and the saw blade, since misalignment causes unsatisfactory results when using the saw, increased maintenance and blade replacement costs, and potential safety hazards.

### SUMMARY OF THE INVENTION

An embodiment of the invention is directed to a power table saw having a frame structure configured to support a movable saw assembly. The table saw also includes a rip fence attached to the frame structure in a fixed position for contacting a work piece during a cutting operation by said table saw. Further, a table assembly is provided, having a top surface for supporting a work piece, a blade extendable through an opening in the top surface for cutting a work piece, and a motor mounted beneath the top surface for driving the blade. The table assembly is movably mounted on the frame structure so that the table assembly is adjustable, allowing a user to adjust the distance between the blade and the rip fence.

### BRIEF DESCRIPTION OF THE DRAWINGS

FIG. 1 is a front view of a power table saw according to an embodiment of the present invention;

FIG. 2 is a front-left isometric perspective view of the power table saw of FIG. 1;

FIG. 3 is a front-right isometric perspective view of the power table saw of FIG. 1;

FIG. 4 is a front view of the power table saw of FIG. 1, shown with the frame in an extended position and the blade near the rip fence;

FIG. 5 is a front-right isometric perspective view of the power table saw of FIG. 1, shown with the frame in an extended position and the blade near the rip fence;

FIG. 6 is a front view of the power table saw of FIG. 1, shown with the frame in an extended position and the blade distant from the rip fence;

FIG. 7 is a front-left isometric perspective view of the power table saw of FIG. 1, shown with the frame in an extended position and the blade distant from the rip fence;

FIG. 8 is a front view of the power table saw of FIG. 1, shown with the frame in an extended position and the blade in an oblique position;

FIG. 9 is a front-right isometric perspective view of the power table saw of FIG. 1, shown with the frame in an extended position and the blade in an oblique position; and

FIG. 10 is a front isometric perspective view of a powered table saw according to another embodiment of the present invention.

### DETAILED DESCRIPTION OF THE PREFERRED EMBODIMENTS

Various embodiments of the present invention are shown and described herein which provide relatively compact portable powered table saw having a stationary rip fence. In each of the embodiments, the rip fence is fixed relative to a frame of the saw, and a table assembly is movable, so that a cutting width of the table saw can be adjusted by a user. The rip fence is permanently or semi-permanently attached to the frame in a fixed position, and the table assembly is mounted on the frame so that it is movable relative to the rip fence.

In addition to providing a guide for the movable table assembly, the frame also helps to prevent damage to internal components of the saw assembly. Moreover, at least a portion of the frame in each of the various embodiments is extendable. When extended, the frame allows the table assembly to have a relatively large range of motion, while holding the saw assembly relatively stable Conversely, when the frame is not extended, the table is generally held in place by the frame, and the table saw assembly is relatively compact, allowing for easier transportation of the saw.

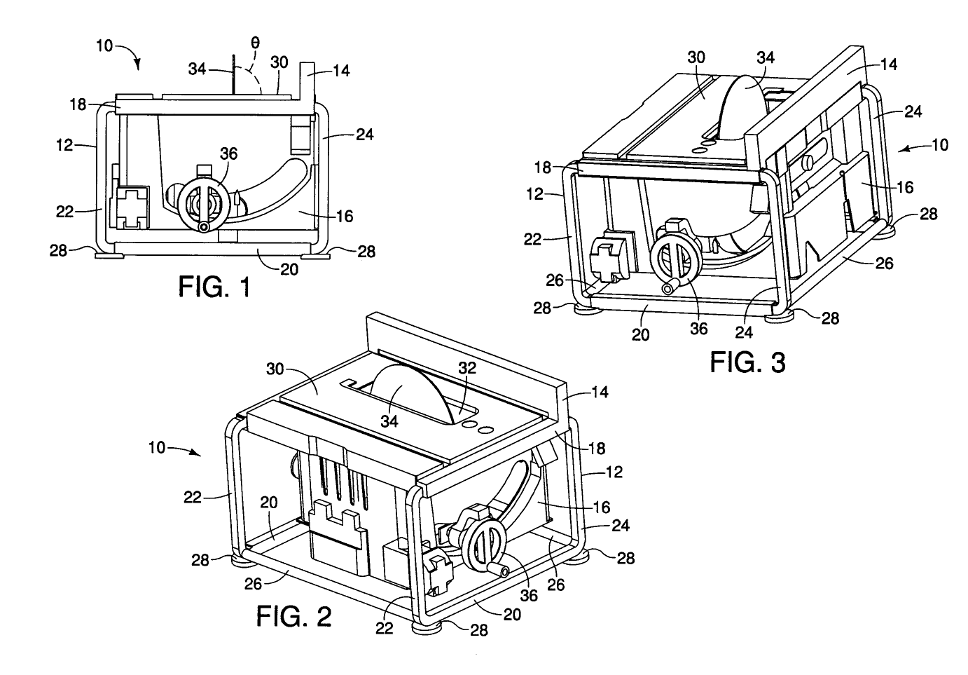

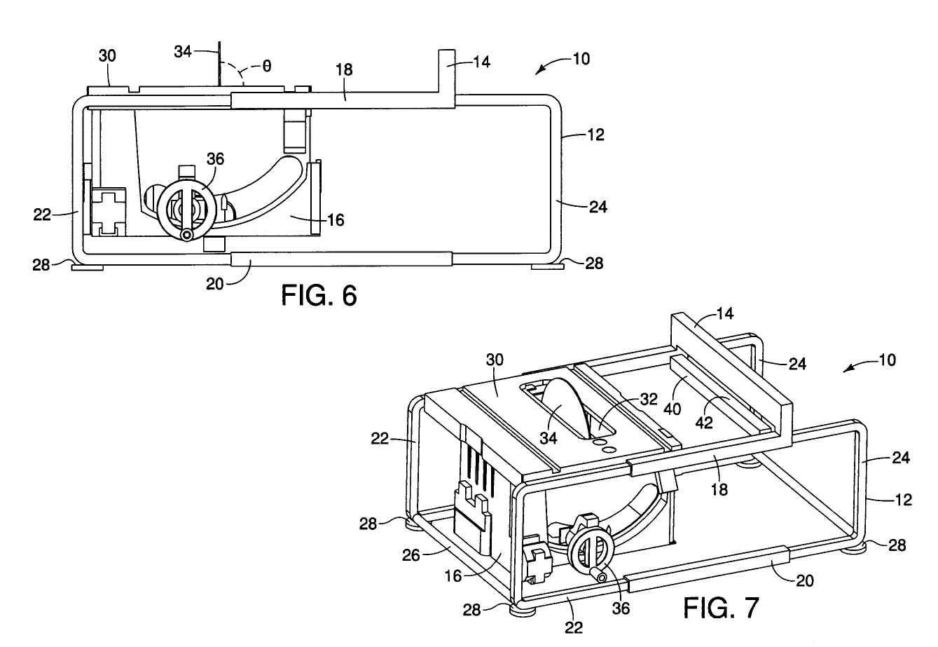

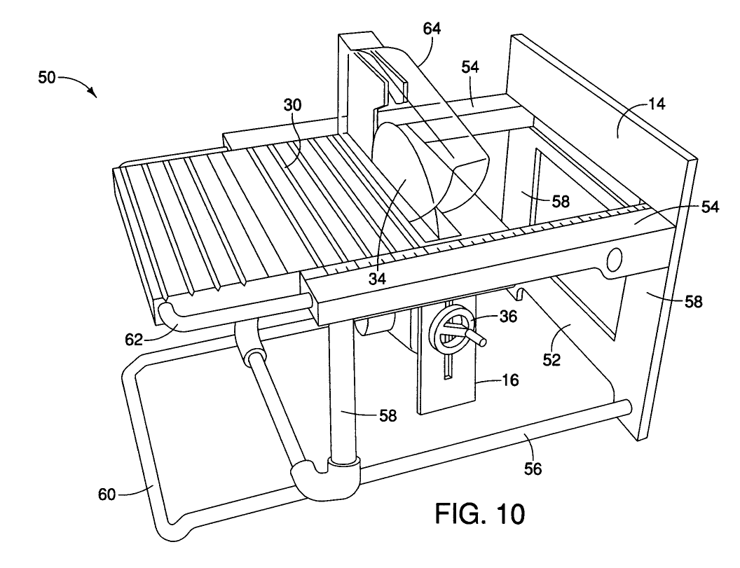

Turning to FIGS. 1-9, a first embodiment of the present invention is shown and comprises a powered table saw assembly that is generally designated at 10. The table saw assembly 10 includes an extendable frame 12, a fixed rip fence 14, and a movable table assembly 16.

The frame 12 is relatively open, allowing a user to easily grip the saw assembly by the frame when moving the saw. Alternatively, it is contemplated that in addition to the open frame design, the frame 12 includes handles for the user to grasp when moving the saw assembly 10. The frame includes a pair of upper rails 18 and a pair of lower rails 20, each preferably formed from hollow tubing. While the rails 18, 20 shown in FIGS. 1-9 are formed from square tubes, the tubing may have any of a variety of cross-sectional shapes. Additionally, the tubing for the upper rails 18 and lower rails 20 is preferably made from metal such as steel, but may be made from any durable, rigid material. Also, the cross-sectional shape of the upper and lower rails 18, 20 may be any conventionally known shape and the material from which the rails are constructed may be any material known to those of skill in the art, provided that the resulting rails are capable of supporting at least the weight of the rip fence 14, table assembly 16 and a work piece.

The upper rails 18 of the frame are separated from one another by a distance sufficient to allow the moving table assembly to be mounted between the upper rails. Additionally, the lower rails 20 are preferably separated from one another by a distance that is approximately equal to the distance between the upper rails 18.

A pair of table-side extension portions 22 and a pair of fence-side extension portions 24 are generally C-shaped, and made of tubing similar to that used in forming the upper and lower rails 18, 20. Specifically, the tubing used to form the extension portions 22, 24 is preferably made from the same material as that of the upper and lower rails 18, 20, and has a similar cross-sectional shape as the rails, but is sized so that horizontal portions of the extension portions fit within the rails, forming a slidable telescoping extension to the rails. Preferably, the rails 18, 20 and extension portions 22, 24 are formed such that a user can easily extend the frame 12 fully when the saw assembly 10 is to be used, while preventing the user from over-extending the frame, which could result in a separation of one or more of the extension portions and one or more of the upper and lower rails. The frame 12 may optionally include a travel limiting mechanism when the extension portions 22, 24 are in a fully extended position. Further, the frame may include limit switches positioned near the extension portions 22, 24 that prevent operation of the saw assembly unless the extension portions are in the fully extended position.

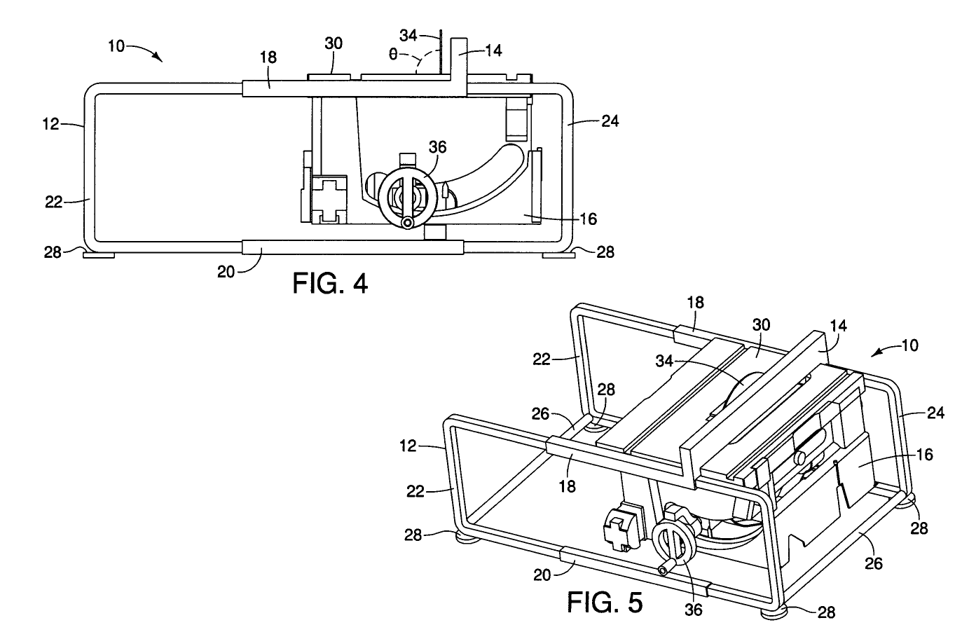

As is shown in FIGS. 4, 5, 8, and 9, a length of the horizontal portions of the fence-side extension portions 24 is preferably selected so that a portion of the table assembly 16 may pass below the rip fence 14. A length of the horizontal portion of the table-side extension portions is selected to determine a travelling distance for the movable table assembly 16. The extension portions 22, 24 also separate the upper rails 18 from the lower rails 20 by a distance sufficient to fully accommodate the table assembly 16

The frame 12 further includes one or more horizontal cross-pieces 26 mounted between the table side table-side extension portions 22 and also between the fence-side extension portions 24. The horizontal cross-pieces 26 provide additional stability and rigidity to the frame 12. Additionally, the cross-pieces 26 may serve to limit the movement of the table assembly 16.

The frame 12 also optionally includes feet 28 attached to the bottom of the frame. The feet 28 are used to stabilize the frame and to provide a non-skid surface to help hold the saw assembly 10 stationary. The feet 28 may be attached to the frame 12 via screws or bolts, adhesives, welds, or any other method known in the art.

The rip fence 14 is mounted on the frame 12 and is fixedly attached to the frame's upper rails 18, such that the rip fence is stationary with respect to the upper rails. The fence 14 therefore maintains a constant position and orientation relative to the upper rails 18. The rip fence 14 may be attached to the upper rails using permanent or semi-permanent fasteners such as screws, bolts, rivets, adhesives, or the like, or may be integrally formed with the upper rails 18. Moreover, the rip fence is preferably elevated slightly relative to the upper rails 18, allowing the movable table assembly 16 to pass at least partially beneath it.

The rip fence 14 is generally planar, and is used for guiding a work piece across the saw assembly 10. The rip fence 14 is preferably constructed from aluminum or steel, but may be made of any durable material with a relatively low coefficient of friction, allowing the work piece to slide easily along the fence.

The movable table assembly 16 is also mounted on the frame 12 and travels along the rails, allowing a user to adjust a cutting width for the saw assembly 10. The table assembly 16 is movably attached to the upper rails 18 of the frame 12 using, for example, casters, ball bearings, drawer slides, or the like, so that the table assembly 16 can move freely along a single axis perpendicular to the rip fence 14. Additionally, it is contemplated that the table assembly 16 be attached to the lower rails 20 using a similar mounting mechanism to provide additional support and stability.

The movable table assembly 16 may also include a locking mechanism used to hold the table assembly in place during a cutting operation. Further, the table assembly 16 includes a generally planar top surface 30 positioned higher than the upper rails 18 to allow a miter gauge to be inserted in miter slots on the table assembly. The top surface 30 made from a durable material, such as aluminum or steel, and is designed to help support and guide a work piece during operation of the saw assembly 10. Further, the top surface 30 defines an opening 32, allowing at least a portion of a saw blade 34 to pass through the opening and extend vertically above the top surface.

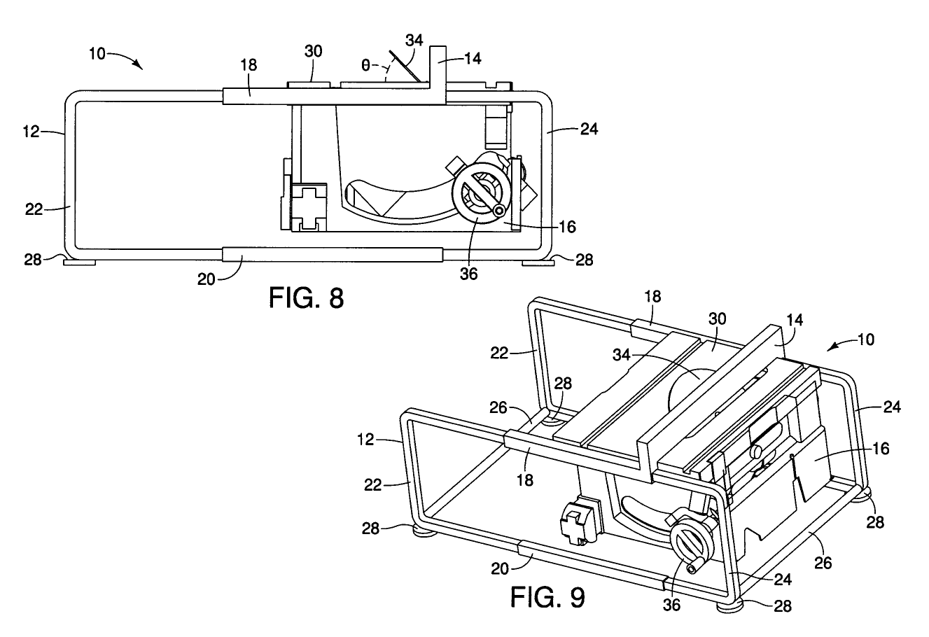

The saw blade 34 is any conventionally known blade for use in table saws. The blade's position may be altered by raising or lowering the blade 34 relative to the top surface 30, or by tilting the blade to alter an angle θ between the blade and the top surface (i.e., a bevel angle). The bevel angle θ is adjusted using, for example, a crank and gear system 36 as shown in FIGS. 1-9. The bevel angle can be adjusted within a range of about 45° to about 90°. As an example, FIGS. 1, 4, and 6 show that the angle θ between the blade 36 and the top surface 30 is approximately 90°, while FIG. 8 shows the angle θ between the blade and the top surface is acute.

Additionally, it should be noted that the generally planar surface of the rip fence 14 is configured to contact a work piece in a plane that is generally parallel to a plane defined by the blade 34 when the bevel angle is set to 90°. This helps to produce a clean cut from the saw blade and reduce the potential for work piece kickback.

A motor (not shown) mounted within the table assembly 16 drives the blade 34, and may also be used to drive optional added components such as a vacuum for collecting sawdust or the like. The motor may be any conventionally known electrical or internal combustion motor capable of driving the saw blade at sufficient speed and power to cut through a variety of work pieces. Moreover, the motor may drive the blade 34 either directly or indirectly through, for example, a belt system. A switch controlling operation of the motor is preferably mounted on the table assembly, so that the switch moves with the table assembly. Alternatively, the switch may be mounted on the frame so that the switch remains in a stationary position even if the table assembly is moved.

As shown in FIG. 7, an additional support table 40 is preferably attached to the rip fence 14 for supporting a work piece during operation of the saw assembly 10. The additional support table 40 is preferably removable or retractable so that it can be withdrawn so that it does not interfere with movement of the movable table assembly 16 or work piece when the table assembly is disposed in the vicinity of the rip fence 14, and can be positioned to support the work piece when the table assembly is relatively distant from the rip fence. The additional support table 40 is disposed so that a top surface 42 of the additional support table is relatively coplanar with the table assembly top surface 30.

Turning now to FIG. 10, a second embodiment of the present invention is shown and comprises a table saw assembly generally designated at 50. The saw assembly 50 shares many components with the saw assembly 10 as shown in FIGS. 1-9, and like components have been designated using like reference numerals.

As shown in FIG. 10, the table saw assembly 50 includes a rip fence 14 and a movable table assembly 16, both mounted on a frame 52. The frame 52 includes a pair of upper rails 54 and a pair of lower rails 56, separated by vertical supports 58. Further, a lower extendable portion 60 is slidably attached to the lower rails 56, so that it can be extended, providing increased stability to the assembly 50. As in the first embodiment, one or more travel limiting mechanisms may be used with the extendable portion.

The rip fence 14 is fixedly mounted to the upper rails 54, and is slightly raised relative to the upper rails, so that a portion of the movable table assembly 16 may pass beneath the fence. This configuration allows for making relatively narrow-width cuts in a work piece, since the blade can be positioned very close to the rip fence, without regard to the top surface 30 of the table assembly 16.

As shown in FIG. 10, the table assembly 16 is slidably mounted to the upper rails 54 using drawer slides 62. Alternatively, the table assembly 16 could be mounted to the upper rails 54 using casters, bearings, or the like, as described in the first embodiment. If the table assembly is mounted using drawer slides 62 as shown, the table assembly 16 can travel beyond the upper rails 54, eliminating the need to extend the upper rails while retaining a relatively large range of motion. This results in a more compact footprint for the saw assembly 50, increasing the ease of portability.

Also included is a safety guard 64 that at least partially surrounds a blade 34 on the movable table assembly 16. The safety guard 64 is pivotably mounted in on the movable table 16 so that a work piece may pass beneath the cover to contact the blade 34. However, the guard 64 helps to retain sawdust and debris created by the blade 34, and additionally helps to prevent extraneous material from entering the blade's cutting path. Thus, the safety guard 64 helps to reduce accidental injury to a user's hands by reducing the possibility that the user's hand can contact the blade 34.

While specific embodiments of the present invention have been shown and described, it should be understood that other modifications, substitutions, and alternatives are apparent to one of ordinary skill in the art. Such modifications, substitutions, and alternatives can be made without departing from the spirit and scope of the invention, which should be determined from the appended claims.

Various features of the invention are set forth in the appended claims.

1. A power table saw comprising:
a frame structure configured to support a movable table assembly;
a rip fence attached to said frame structure in a fixed position for contacting a work piece during a cutting operation by said table saw;
said table assembly comprising a main table having a top surface for supporting a work piece, a blade extendable through an opening in said top surface for cutting a work piece, a motor mounted beneath said top surface for driving said blade, said table assembly being movably mounted on said frame structure so that said table assembly is adjustable to adjust the distance between said blade and said fence.

2. The power table saw of claim 1, said frame comprising one or more pairs of rails, spaced apart by a distance sufficient to accommodate said table assembly.

3. The power table saw of claim 2, wherein said frame includes a pair of upper rails and a pair of lower rails.

4. The power table saw of claim 3, wherein said upper rails and said lower rails are made of metal tubing.

5. The power table saw of claim 2, said frame including one or more extendable portions.

6. The power table saw of claim 5, wherein each of said one or more extendable portions is a slidable telescoping extension.

7. The power table saw of claim 3, wherein said table assembly is slidable on at least one of said pairs of rails.

8. The power table saw of claim 7, wherein said table assembly is slidable on said upper rails.

9. The power table saw of claim 8, wherein said table saw is slidable on both said upper rails and said lower rails.

10. The power table saw of claim 1, said fence being slightly elevated such that said table assembly can pass at least partially beneath said fence.

11. The power table saw of claim 1, wherein a bevel angle of said blade is adjustable.

12. The power table saw of claim 1 wherein a face of said fence is configured to contact a work piece at a plane that is parallel to a plane defined by said blade.

13. The power table saw of claim 1, wherein said table assembly further includes a locking mechanism that selectively inhibits movement of said table assembly.

14. The power table saw of claim 1, wherein a height of said blade is adjustable.

15. The power table saw of claim 1, further comprising an additional support table attached to said rip fence.
